(19) United States
(12) Patent Application Publication
(10) Pub. No.: US 2003/0188201 A1
(43) Pub. Date: Oct. 2, 2003

(54) Method and system for securing access to passwords in a computing network environment

(75) Inventor: Vishwanath Venkataramappa, Austin, TX (US)

Correspondence Address: Darcell Walker, Suite 250, 9301 Southwest Freeway, Houston, TX, 77074, US

(73) Assignee: INTERNATIONAL BUSINESS MACHINES CORPORATION, ARMONK, NY

(21) Appl. No.: 10/112,515

(22) Filed: Mar. 28, 2002

(51) Int. Cl. H04K 1/00

(52) U.S. Cl. 713/202

(57) ABSTRACT

The present invention provides a method and system to secure the storage and retrieval of user and resource passwords in a distributed computing network environment. The system incorporates a password server. This server can be a stand-alone device or can be implemented in a server on a network. The password server contains software programs that store and distribute the passwords securely to proper applications (users).

In the method of the present invention, the password server program stores the password in a file encrypted using the password server's public key. Only the password server has the corresponding private key. Therefore, no one except password server can decrypt the password. Applications can store their password in the password server after encrypting the password using password servers public key. The method of the present invention has an advantage over conventional password storage practices in that there is only the need to secure the password server in order to prevent lost or theft of passwords. Because user passwords usually reside on the same system as the application user, it is necessary to implement security measures to secure the password information stored on that machine.

### FIELD OF THE INVENTION

This invention relates generally to a method and system for controlling user access to computer system resources and in particular the present invention relates to a method and system for controlling access to resource and user passwords in a computing network environment.

### BACKGROUND OF THE INVENTION

In any computer system, there is an inherent security risk when intruders that have malicious purposes can access sensitive or classified information using normal accessing channels. Unauthorized users can cause many problems for computer systems. These users may modify software to cause unwanted events to occur or to benefit themselves. The unauthorized users may also access private or classified data, or copy proprietary software. While doing all this, they can seriously impact all computer-based operations when their use of computer resources causes deterioration of response times or denial of service for legitimate users. Such unauthorized access can be accomplished in a number of ways, for example, the user can claim to be someone else, the user can divert the access path to another computer system, or the user accesses the system before a legitimate user logs off the system.

In addition, access can be gained by persons who observe a legitimate logon session within an open communication network and later masquerade as that legitimate user by using the information seen during the observation. Simple, user-selected and often personally related passwords can be “guessed” by intruders or programs written by the intruders. Legitimate sessions may be recorded from the communication network for later playback or an intruder may “piggyback” a legitimate session by using the system before the user has logged out. To guard against external attacks, computers and computing systems must have internal mechanisms that intercept unauthorized attempts to access the computers and resources in a computing system.

Computer security techniques have been developed to protect single computers and network-linked computer systems from accidental or intentional harm, which can result in destruction of computer hardware and software, physical loss of data, deception of computer users and the deliberate invasion of databases by unauthorized individuals. Computers and the information contained therein are considered confidential systems because their use is typically restricted to a limited number of users. As mentioned, confidentiality and the possession of information can be violated by shoulder surfing, or observing another user's computer screen; tricking authorized users into revealing confidential information; wiretapping, or listening in on or recording electronic communications; and stealing computers or information. A variety of simple techniques currently exist to prevent computer crime. For example, destroying printed information, protecting computer screens from observation, keeping printed information and computers in locked cabinets, and clearing desktops of sensitive documents prevent access to confidential information. Although these basic procedures can insure some minimum level of security, more sophisticated methods are also necessary to prevent computer crimes.

One technique to protect confidentiality is encryption. Information can be scrambled and unscrambled using mathematical equations and a secret code called a key. Two keys are usually employed, one to encode and the other to decode the information. The key that encodes the data, called the public key may be possessed by several senders. The key that decodes the data, called the private key is possessed by only one receiver. The keys are modified periodically, further hampering unauthorized access and making the encrypted information difficult to decode or forge.

Another technique to prevent computer crime is to limit access of computer data files to approved users. In order to implement a security policy controlling the exchange of information through a personal computer or throughout a computing system, some mechanism has to exist for uniquely identifying each user of the network system. Only in this manner can there be a determination and control of the access rights of each system user. This process of identifying and verifying a “principal” (e.g., a user) on the network, is known as “authentication.” Access-control software verifies computer users and limits their privileges to view and alter files. Records can be made of the files accessed, thereby making users accountable for their actions. Military organizations give access rights to classified, confidential, secret, or top secret information according to the corresponding security clearance level of the user.

The use of passwords to authenticate users is the most prevalent means of controlling access currently in use. Passwords are confidential sequences of characters that give approved users access to computers. To be effective, passwords must be difficult to guess. Effective passwords contain a mixture of characters and symbols that are not real words. To thwart imposters, computer systems usually limit the number of attempts to enter a correct password.

In many cases, the users select their own passwords or continue to use the group password. Studies have shown that most users select passwords that are easy to remember, generally personal in nature and seldom change them. Under these circumstances, passwords are easy to guess either by a motivated individual or a simple program using a random word generation technique. Some systems may use an authentication means such as requesting the user to supply a sequence of names, etc. in conjunction with a password. This makes entry more difficult but is still vulnerable if the logon procedure is observed and the response identified or the expected response is easy to guess.

Another method for authenticating a user is through the use of a secret password. Under this method, each system user is given a secret password and it is assumed that only that user has access to the password. A list is then maintained in memory in the personal computer or computing system's memory that matches each user with his password. To authenticate a user under this method, a process running on the personal computer or in the computer system generally prompts the user to type in his user name and password. If the entered password matches the stored password for that user, the process concludes that the user is who he says he is and allows the user to login to the personal computer or the computing system. In other words, the entry of a correct password “authenticates” the user.

Still, another password based protection scheme includes tokens such as tamper-resistant plastic cards with microprocessor chips that contain a stored password that automatically and frequently changes. When a computer is accessed using a token, the computer reads the token's password, as well as another password entered by the user, and matches these two to an identical token password generated by the computer and the user's password, which is stored on a confidential list. In the future, passwords and tokens may be reinforced by biometrics, identification methods that use unique personal characteristics, such as fingerprints, retinal patterns, skin oils, deoxyribonucleic acid (DNA), voice variations, and keyboard-typing rhythms.

The conventional method related to controlling user access in a distributed processing environment is to request users to separately log on to each computer that provides needed services. A user must repeatedly provide user identification (ID) codes and passwords to gain access to various services located throughout the system. This practice has many drawbacks. For instance, a user must log on to a workstation, then log on to new computers when new services are needed. The repetition of these logon sequences is very inconvenient for users. Moreover, if user passwords are not the same on all computers in the system, a user may need to remember many different passwords. To reduce the possibility of using a wrong password, the user might write them down (perhaps posted somewhere close to the workstation). These techniques are not secure practices to protect computer resources. In addition, a user who is in a hurry to obtain information from a particular resource may not wish to go through the repeated logon process. He or she may find ways to bypass the security procedures used in the system, which creates a system weakness. Another weakness is the practice of transmitting passwords in the clear without security. In remote logon situations, the user's identification code and password must be transmitted to the remote computer. Without a secure path from the user's workstation to the remote computer, anyone having access to the system could use a network analyzer to discover the password of the user.

The configuration of a network can influence the security methods implemented to protect the network. A large network may include a large number of different application programs each of which requires a separate password and a separate sign-on identity. FIG. 1 illustrates a typical computer network. As shown in FIG. 1, a user 10 has a connection to a local computer 11 which is in turn connected to a network 12. The network in turn is connected to a number of systems which contain application programs 15A to 15E. The user can access and sign on to each of the applications 15A to 15A. Each of the applications 15A to 15E may require a separate sign-on identification and a separate password.

As previously mentioned, it is not uncommon for a single user to have a list of ten or even twenty sign-on ID's and passwords that the user must enter into the system at different times. Posting a list of sign-on ID's and passwords near a terminal is a terrible security risk; however, it frequently happens.

Operating Systems store users' passwords in a password file. The passwords are stored after they are converted to another string using a one-way hash function. When a user enters his/her identification and password the operating system converts the password using the same one-way hash function and compares the result with that stored in the password file. This approach is useful only when the user remembers his/her password and uses it interactively.

In many computer applications, the software application programs within the system may need to access other computer resources in order to perform some task for a user. The resource for which the application software may need to access for security purposes may require the application software to provide a password in order to achieve access to that resource. This authentication process occurs at a level transparent to the high-level user. In these cases, the applications need to retrieve user's password at runtime without the user's interaction. In addition, for these cases, the computer containing the application software must maintain security to protect the passwords for a particular application software program. If a particular computer did not have adequate security measures, the passwords for an application program could be retrieved and used to gain access to system resources. There remains a need to securely store the users' passwords for all users (including application software programs) and also there is a need for the application to retrieve it's password securely.

### SUMMARY OF THE INVENTION

It is an objective of the present invention to provide a method and system for controlling access to computing system resources.

It is a second objective of the present invention to provide a method and system for controlling access to user and resource passwords in a computing system.

It is a third objective of present invention to provide a separate storage location on a computing network to secure passwords for system resources and users.

It is a fourth objective of the present invention to provide a method to securely transmit and store passwords for users and resources using encryption and decryption techniques.

It is a fifth objective of the present invention to provide a method to retrieve and transmit requested passwords from a password storage location over a communication network to a requesting user or resource using secure data transmission techniques.

The present invention provides a method and system to secure the storage and retrieval of user and resource passwords in a distributed computing network environment. The system of the present invention incorporates a password server. This server can be a stand-alone device or can be implemented in a server on a network. The password server contains software programs that store and distribute the passwords securely to appropriate applications (users/resources). This system can also contain an application server which represents software application resources on the system that have passwords.

In the method of the present invention, the password server program stores the password in a file encrypted using the password server's public key. Only the password server has the corresponding private key. Therefore, no device or resource except password server can decrypt the password. Applications can store their passwords in the password server after encrypting the password using password servers public key.

The password server must authenticate an application program (user) before the password server will respond to a password storage or retrieval request from the user. The authentication mechanism can be one such as the DCE based or Kerberos based method or it can be client certificate based method. Once the user is authenticated to the password server, an encrypted user password can be sent to the password server for storage or a user password can be retrieved and returned to an application on the application server securely over a secure communication channel. The communication protocol used in this transmission can be secure socket layer (SSL) protocol.

The method of the present invention involves two processes: 1) password storage and 2) password retrieval. Each process involves interaction between the password server and another application server on the network. The storage process comprises the steps of: 1) establishing a connection between the password server and application server, 2) authenticating the application server by the password server, 3) encrypting the password using the password server's public key, 4) receiving the encrypted password and 5) storing the encrypted password in the password server.

The password retrieval process comprises the steps of: 1) establishing a connection between the password server and application server, 2) authenticating the application server for the appropriate application by the password server, 3) retrieving the encrypted password, and 4) sending the encrypted password in the password server to the requesting application.

The method and system of this invention will provide a more secure protection of passwords for system resources and users. This invention will also greatly reduce the need to have substantial security measures on each application server to protect passwords for applications contained on that server.

### DESCRIPTION OF THE DRAWINGS

FIG. 1 is a diagram of a conventional network configuration in which a user must sign on to each application program.

FIG. 2 is a diagram of a computer network over which messages and transactions may be transmitted.

FIG. 3 is an overview diagram of the network system configuration of the present invention.

FIG. 4 is a flow diagram of the password storage operation of the present invention.

FIG. 5 is a flow diagram of the password retrieval operation of the present invention.

FIG. 6 is a detailed flow diagram of the steps performed by an application server during the password storage operation of the present invention.

FIG. 7 is a detailed flow diagram of the steps performed by a password server during the password storage operation of the present invention.

FIG. 8 is a detailed flow diagram of the steps performed by an application server during the password retrieval operation of the present invention.

FIG. 9 is a detailed flow diagram of the steps performed by a password server during the password retrieval operation of the present invention.

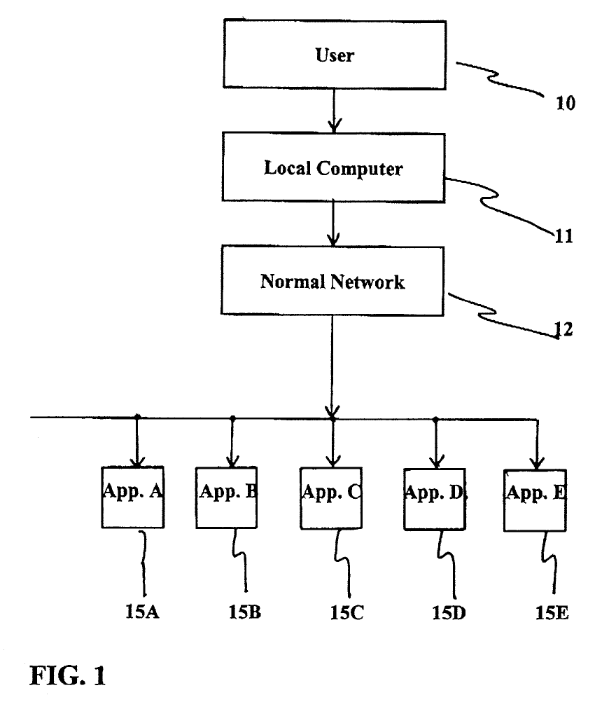

### DETAILED DESCRIPTION OF THE INVENTION

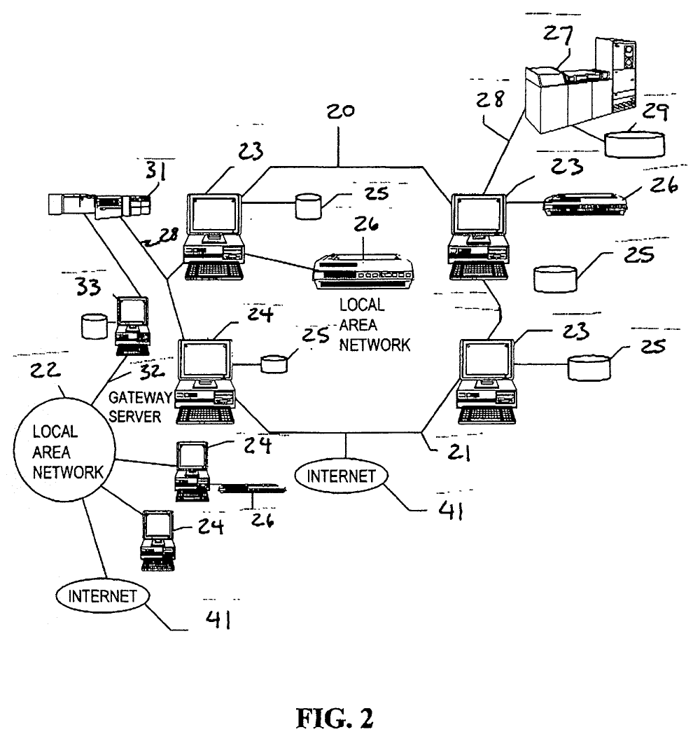

The description of the present invention will in the context of an application server that will represent a user or application resource in the system. The present invention provides for the protection of passwords of system resources. The invention can be implemented distributed computing system. In this manner the component of the system can be positioned in multiple locations. Once such network could be a global computer network environment such as the Internet. With reference now FIG. 2, there is depicted a pictorial representation of a distributed computer network environment 20 in which one may implement the method and system of the present invention. This diagram illustrates the types of components through which sensitive and confidential; voting information may be exposed and the need for extreme security in this voting process. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS) which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

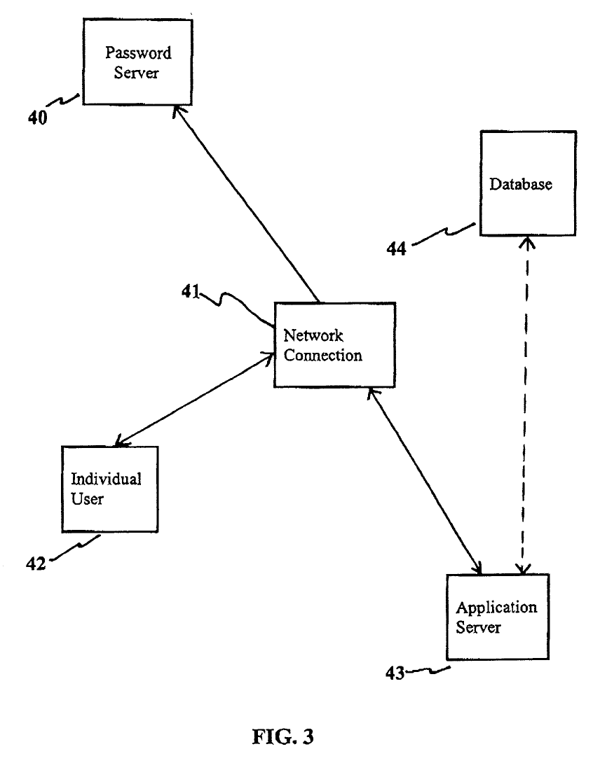

FIG. 3 shows the main configuration of the components of the password security system of the present invention. As shown, the system can be implemented in a computing network. The password protection components can reside in a dedicated password server 40 that is connected via a computer network 41 to system users and applications. The only function of this server 40 would be to securely store the passwords for the system users. These system users can be individuals 42 or software applications on the system. The software applications can reside in application servers 43 at various locations on the network.

The individual user may be required to use a password to access certain system resources. The individual user can have the option of storing a specific password for access to a specific resource in the password server. When the individual user desires to access that resource, the user would retrieve the specific password for that resource from the password server. The ability to store and retrieve passwords would relieve the user of the task of remember numerous passwords or risking security by using the same password for access to many different resources.

An application program on the application server 43 may need to access a system resource such as a database 44 during the performance of a task. However, this access may require the application program to provide a password to gain access to the database. Unlike the individual user, this access does not involve an external user. The application user can also access the password server and retrieve a previously stored password for access to a specific resource such as the database 44 by a specific application user 43. Once the application program has the appropriate password, it can access the database and complete the task.

Because the activities of the present invention will involve the transmission of confidential and critical information (system resource and application passwords) over public networks, there needs to be a strong security features to prevent unwelcome access and to protect private data as it traverses the public network. User authentication and Data Encryption schemes provide the ability to authenticate, encrypt and decrypt certain information. This present invention implements a public key/private key encryption scheme to protect data as it traverses the public networks. The following description is one of some encryption and decryption schemes that can be used to secure the transmission of confidential information over a public network.

Symmetric, or private key, encryption (also known as conventional encryption) is based on a secret key that is shared by both communicating parties. The sending party uses the secret key as part of the mathematical operation to encrypt (or encipher) plaintext to ciphertext. The receiving party uses the same secret key to decrypt (or decipher) the ciphertext to plaintext. Examples of symmetric encryption schemes are the RSA RC4 algorithm (which provides the basis for Microsoft Point-to-Point Encryption (MPPE), Data Encryption Standard (DES), the International Data Encryption Algorithm (IDEA), and the Skipjack encryption technology proposed by the United States government (and implemented in the Clipper chip).

Asymmetric or public key encryption uses two different keys for each user: one key is a private key known only to the user to which the key pair belongs; the other is a corresponding public key, which is accessible to anyone. The encryption algorithm mathematically relates the private and public keys. One key is used for encryption and the other for decryption, depending on the nature of the communication service being implemented. In addition, public key encryption technologies allow digital signatures to be placed on messages. A digital signature uses the sender's private key to encrypt some portion of the message. When the message is received, the receiver uses the sender's public key to decipher the digital signature as a way to verify the sender's identity and the integrity of the message.

With symmetric encryption, both the sender and receiver have a shared secret key. The distribution of the secret key must occur (with adequate protection) prior to any encrypted communication. However, with asymmetric encryption, the sender uses the recipient's public key to encrypt or digitally sign messages, while the receiver uses their private key to decipher these messages. The public key can be freely distributed to anyone who needs to encrypt messages to the owner of the public key or to verify digitally signed messages by the private key that corresponds to the public key. The owner of the key pair only needs to carefully protect the private key.

To secure the integrity of the public key, the public key is published with a certificate. A certificate (or public key certificate) is a data structure that is digitally signed by a certificate authority (CA). The CA is an authority that users of the certificate can trust. The certificate contains a series of values, such as the certificate name and usage, information identifying the owner of the public key, the public key itself, an expiration date, and the name of the certificate authority. The CA uses its private key to sign the certificate. If the receiver knows the public key of the certificate authority, the receiver can verify that the certificate is indeed from the trusted CA, and therefore contains reliable information and a valid public key. Certificates can be distributed electronically (via Web access or e-mail), on smart cards, or in an LDAP database. Public key certificates provide a convenient, reliable method for verifying the identity of a sender. IPSec can optionally use this method for end-to-end authentication.

This invention utilizes public and private key pairs for each party involved in the storage and retrieval transactions. A public and private key pair is a unique association of key values wherein one key can encrypt information and the other can decrypt. For example, the public key can encrypt data and only the corresponding private key can decrypt the data. Public and private keys are used for signing and sending encrypted messages. A public key is typically made available to users on a global computer network (the Internet) within a certificate stored in a publicly accessible Lightweight Directory Application Protocol (LDAP) directory. The associated private key is kept in confidence by the entity, such as the person or cooperation that owns the key pair.

As previously mentioned, one solution for single sign-on and authentication in a distributed computing environment is known as “Kerberos.” Kerberos is an authentication protocol developed as part of Project Athena at Massachusetts Institute of Technology. Kerberos provides an excellent platform for single sign-on and authentication in an open network environment. Unfortunately, Kerberos support is not transparent and requires various custom modifications to the applications as well as the system utilities by a way often referred to as “Kerberizing.” As the popularity of Kerberos grows in recent years, many operating systems and application vendors are beginning to provide support for Kerberos, but this support is far from universal. For this reason, it is not possible to solely rely upon Kerberos as the only means for single sign-on in a distributed computing environment.

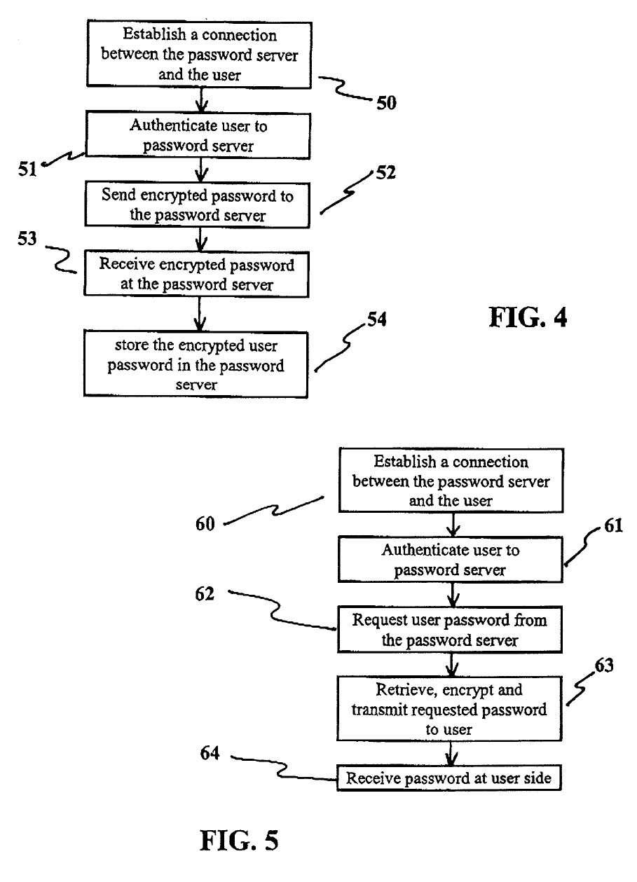

The method of the present invention comprises two basic activities, the storage of user passwords on a secure password server and the secure retrieval of the user passwords from the secure password server. FIG. 4 is a flow diagram of the general password storage operation of the present invention. The storage operation will establish a password directory and database for passwords for the various system users. As previously mentioned, the users can be individuals or system applications. A particular user may several different passwords that are used to access various system resources. The storage and retrieval operations are interactive activities between the password server and a user. In this process, the initial step 50 is establishment of a connection between the password server and the user. After the connection occurs, in step 51 the user is authenticated by the password server. The authentication process can occur using conventional authentication procedures. In step 52, the user sends an encrypted password to the password server. This password will be the specific one for this user when the user attempts to access a certain resource on the system or network. The password server receives the encrypted password in step 53 and stores the password in step 54.

FIG. 5 illustrates the general steps of the password retrieval operation of the \present invention. As with the storage operation, steps 60 and 61 comprise the connection and authentication of the user server to the password server. In step 62, the user sends a request to the password server for the user password to a specific resource. The password server, in step 63, retrieves the requested password, encrypts the password and transmits the password to the requesting user. In step 64, the user receives the requested password in an encrypted form. The user then decrypts the password using the user server's private key or a shared key. The shared key is between the password server and the application server.

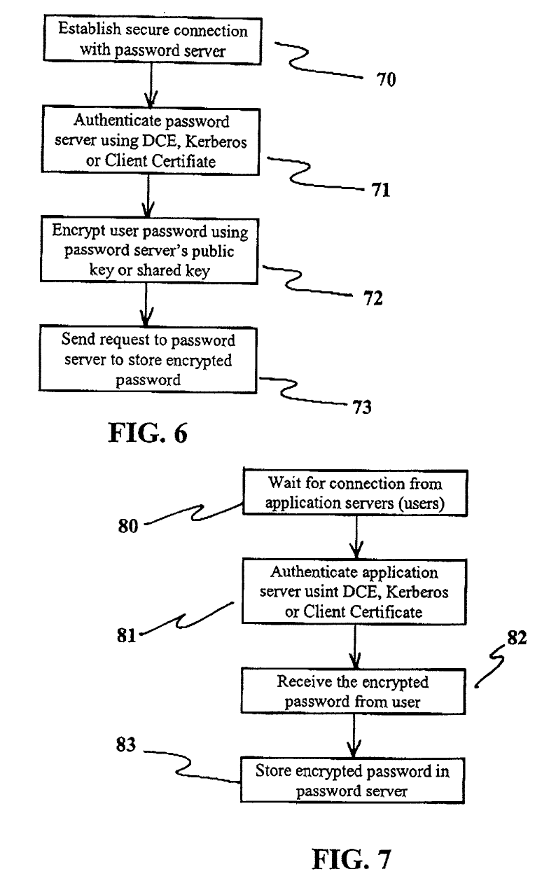

FIG. 6 illustrates the detailed steps of the application server/user in the password storage operation of the present invention. As previously stated, the initial step 70 of this application server is to establish a secure connection to the password server. In step 71, the password server authenticates the application server. After this authentication, in step 72, the application server will encrypt the password using the public key of the password server. The encryption can also be with a shared key between the password server and the application server. Following the encryption of the password, the application server sends a request 73 to the password server to store the password for that application server. This request can contain information about the specific resource for which the application server will use the password. This information will be transmitted along with the password to the password server. The transmission can be over a secure communication channel such as SSL. The password server can store the password in files in a manner similar to conventional password storage procedures. However, with the present invention, the password server has protections to secure the files.

FIG. 7 illustrates the detailed steps of the password server in the password storage method of the present invention. Initially, the password server is in a “wait” state 80. Once a user establishes a secure connection, the password server authenticates the user 81. This authentication process can be performed with methods such as DCE, Kerberos or the Client Certificate method. In step 82, the password server receives the encrypted password from the user. Next, the password server stores the decrypted password in a location in the password server 83. Even though the password is encrypted, the password server has information that identifies the password with the appropriate user or application program and corresponding system resource. The password is stored such that a user and a target resource are associated with the stored password.

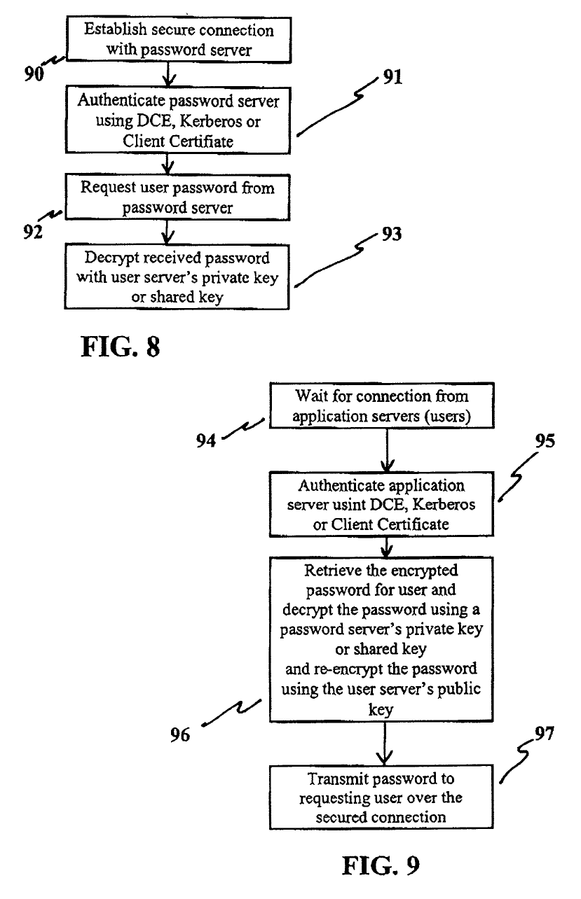

FIG. 8 is a detailed flow diagram of the steps performed by an application server during the password retrieval operation of the present invention. As with any transaction between a user and the password server, the initial step 90 of this application server is to establish a secure connection to the password server and then in step 91 the password server authenticates the application server which will make the request. After this authentication step, the user sends a request to the password server to retrieve the desired user password 92. As mentioned this request should contain information identifying the particular resource that the user wants to access. In step 93, the user sever receives the requested password from the password server. The user then decrypts the received password with the user server's private key.

FIG. 9 is a detailed flow diagram of the steps performed by a password server during the password retrieval operation of the present invention. As with the storage process, initially, the password server is in a “wait” state 94. Once a user establishes a secure connection, the password server authenticates the user 95. At this point, the password server receives the request to retrieve a password from the user. The password server determines the appropriate password to retrieve based in the user identity and the identity of the resource that the user wants to access. After the determination of the appropriate password, in step 96, the password server retrieves the encrypted password from the server files. If the password was originally sent to the password server using the password server's public key, the password server will use it's private key to decrypt the password. The password server will then encrypt the password using the public key of the requesting application server prior to transmission of the password to the application server.

If the password was originally sent to the password server using a shared key, the password server can at the time of the initial receipt of the password from the application server, decrypt the password using the password server's private key. At this point, the password server would store a decrypted password. At the time of the request, the password server would retrieve the decrypted password and encrypt the password using the application server's public or shared key. In step 97, the password server transmits this encrypted password to the requesting user in encrypted form. The user receives the password, decrypts it and uses to gain access to system resources.

The method of the present invention has an advantage over conventional password storage practices in that there is only the need to secure the password server in order to prevent lost or theft of passwords. Because user passwords usually reside on the same system as the application user, it is necessary to implement security measures to secure the password information stored on that machine. Also as previously mentioned, with the present invention, users do not need to maintain several passwords to access different resources. The user also does not need to user the same password for access to several resources and risk the discovery of the user password which could allow an unauthorized access multiple resources under the name of the user.

The present invention uses encryption and decryption techniques to secure the password information during transmission of the information over a public communication network. As previously described, there are several encryption/decryption schemes that can be implemented to provide secure transmission of information. Although, the present invention only describes a limited number of schemes, the present invention can be implemented using a variety of encryption/decryption schemes. The particular scheme chose for a system implementing the present invention will depend on the specific needs and objectives of the system.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for securing passwords for system resources in a distributed computing environment comprising the steps of:
creating a secure password storage repository at a separate storage location on the computer network, the repository containing passwords for system resources;
authenticating a system resource requesting the retrieval of a password from the password server;
retrieving from the password repository a password for the requesting resource;
encrypting the retrieved password for transmission to the authenticated resource requesting the password; and
transmitting the retrieved password to the requesting system resource.

2. The method as described in claim 1 wherein said encrypting step further comprises the steps of:
retrieving a stored encrypted password from the repository;
decrypting the password; and
encrypting the password using the user server's public key.

3. The method as described in claim 1 wherein said encrypting step further comprises the steps of:
retrieving a stored decrypted password from the repository; and
encrypting the password using the user server's public key.

4. The method as described in claim 1 wherein said password repository creation step further comprises the steps of:
establishing a connection between a password server and an application server containing a resource having a password for storage in the password repository;
authenticating the application server at the password server;
transmitting an encrypted password from the application server to the password server;
receiving the encrypted password at the password server; and
storing the received password in the storage repository.

5. The method as described in claim 4 further comprising before said transmission step, the step of encrypting the resource password using the password server's public key or the shared key.

6. The method as described in claim 4 further comprises before said storing step, the step of decrypting the received password using the password server's private key.

7. The method as described in claim 4 further comprising before said password transmitting step, the step of sending a request to the password server to store an encrypted password, said request can contain information about the system resource submitting the password, and the system resource for which access will be granted to the submitting resource.

8. The method as described in claim 4 wherein said storing step further comprises storing the password, system resource submitting the password and the system resource to be accessed using the stored password in a secured file in the password server

9. The method as described in claim 1 further comprising after said authentication step, the step of requesting the retrieval of a password from the password server by an application server system resource.

10. The method as described in claim 9 wherein said password retrieval request can contain information about the resource requesting the password and the resource that will be accessed using the requested password.

11. A method for creating a secure password storage repository for securing passwords for system resources in a distributed computing environment comprising the steps of:
establishing a connection between a password server and an application server containing a resource having a password for storage in the password repository;
authenticating the application server at the password server;
transmitting an encrypted password from the application server to the password server;
receiving the encrypted password at the password server; and
decrypting and storing the received password in the storage repository.

12. The method as described in claim 11 further comprising before said transmission step, the step of encrypting the resource password using the password server's public key.

13. The method as described in claim 12 wherein said transmitting step further comprising requesting the password server to store the encrypted password in the password repository.

14. A computer program product in a computer readable medium for securing passwords for system resources in a distributed computing environment comprising:
instructions for creating a secure password storage repository at a separate storage location on the computer network, the repository containing passwords for system resources;
instructions for authenticating a system resource requesting the retrieval of a password from the password server;
instructions for retrieving from the password repository a password for the requesting resource;
instructions for encrypting the retrieved password for transmission to the authenticated resource requesting the password; and
instructions for transmitting the retrieved password to the requesting system resource.

15. The computer program product as described in claim 14 wherein said encrypting instructions further comprise instructions for:
retrieving a stored encrypted password from the repository;
decrypting the password; and
encrypting the password using the user server's public key.

16. The computer program product as described in claim 14 wherein said encrypting instructions further comprise instructions for:
retrieving a stored decrypted password from the repository; and
encrypting the password using the user server's public key.

17. The computer program product as described in claim 14 wherein said password repository creation instructions further comprise:
instructions for establishing a connection between a password server and an application server containing a resource having a password for storage in the password repository;
instructions for authenticating the application server at the password server;
instructions for transmitting an encrypted password from the application server to the password server;
instructions for receiving the encrypted password at the password server; and
instructions for storing the received password in the storage repository.

18. The computer program product as described in claim 17 further comprising before said transmission instructions, instructions for encrypting the resource password using the password server's public key or the shared key.

19. The computer program product as described in claim 17 further comprising before said storing instructions, instructions for decrypting the received password using the password server's private key.

20. The computer program product as described in claim 17 further comprising before said password transmitting instructions, instructions for sending a request to the password server to store an encrypted password, said request can contain information about the system resource submitting the password, and the system resource for which access will be granted to the submitting resource.

21. The computer program product as described in claim 17 wherein said storing instructions further comprise instructions for storing the password, system resource submitting the password and the system resource to be accessed using the stored password in a secured file in the password server

22. The computer program product as described in claim 14 further comprising after said authentication instructions, the instructions for requesting the retrieval of a password from the password server by an application server system resource.

23. The computer program product as described in claim 14 wherein said transmitting instructions further comprise instructions for transmitting the retrieved password to the requesting system resource using a secure socket layer transmission protocol.

24. A system for securing passwords for system resources in a distributed computing environment comprising:
a password server for securely storing system resource passwords, said password server solely dedicated to the storage, protection and retrieval of passwords for system resources;
an application server containing application programs that operate as system user, said application programs having passwords that enable said programs to access system resources; and
a distributed computer network for establishing a connection between said password server and said application server, said computer network providing for the secure transmission of passwords between said password and application servers.

25. The system as described in claim 24 wherein said distributed computer network further comprises individual users that can also access the password server.

26. The system as described in claim 24 further comprising system resources such as database storage facilities on the computer network.

27. The system as described in claim 24 further comprising encryption and decryption software to secure password during storage and transmission between the password server and devices on the computer network.
